(19) United States
(12) Patent Application Publication
(10) Pub. No.: US 2006/0155586 A1
(43) Pub. Date: Jul. 13, 2006

(54) Insurance plan

(76) Inventor: Israel Hirshberg, Alfei Menashe (IL)

Correspondence Address: EDWIN D. SCHINDLER, FIVE HIRSCH AVENUE, P.O. BOX 966, CORAM, NY, 11727-0966, US

(21) Appl. No.: 10/532,640

(22) PCT Filed:
(86) PCT No.: PCT/IL03/00775

(30) Foreign Application Priority Data
Sep. 26, 2002 (IL) 151944

(51) Int. Cl. G06Q 40/00

(52) U.S. Cl. 705/4

(57) ABSTRACT

A list of people committed to donating their own organs, in the event of their own death, to other people on the list of people. A person on the list is a committed organ donor and would receive priority over persons not on the list in receiving an organ transplant should the person on the list require an organ transplantation.

### FIELD OF THE INVENTION

The present invention relates to insurance plans and more specifically to insurance policies for helping human organ transplantations.

### BACKGROUND OF THE INVENTION

Today, there is a severe shortage of human organs for transplantation. In the western countries, about two hundred thousands people, badly needed for organ transplantation, are registered on waiting lists, waiting for organs like kidneys, liver, lungs, hearts and others. These people are waiting many months and even years to receive an organ from those few donors who died in accidents and their relatives donated the deceased organs. The needed people suffer from poor life quality and their body deteriorate during the waiting period due to organ malfunction. These body damages are sometimes irreversible.

Moreover, the economic status of the needed people deteriorate rapidly as they cannot work as healthy people since they are required to be hospitalized frequently for periodical treatments.

The reason for short supply of human organs is that many people refuse to become organ donors without getting anything in return. Another possible reason for not becoming a donor is that nobody likes to think on his own death while he/she is healthy

It is therefore desirable to increase the availability of human organs for organs transplantations.

### SUMMARY OF THE INVENTION

According to the present invention, there is provided a list of people who are committed to donate their own organs in case of their own death, to people included in the list, thus, listed people, in need for organ donation, have priority over non listed people, in receiving the organ donation.

Another aspect of the invention is an organization that represents the interests of the listed people and manages the creation and promotion of the list of organ donors.

Yet another aspect of the invention is that the organization has property rights in the donated organs.

Still another aspect of the invention is that in case there is no demand for organ donation from the listed people, donated organs can be given to the public via hospitals.

Yet another aspect of the invention is that in case where a non-organ insured person gets an organ, he/she will pay the organization, which operates the organs insurance activities, a certain amount of money to cover the organization expenses.

Yet another aspect of the invention is that the list of the organ insured people is either hand written, printed, photocopied, faxed or accessed by any communication device such as telephone, computer, mobile phone and alike and the list is accessed through communication network such as the Internet, telephone networks wireless networks and alike.

Yet another aspect of the invention is that the organization issues an organ insurance policy for people registered on the list, that states their priority in receiving organ donation.

Yet another aspect of the invention is that an organ insurance policy is offered to people whom life are insured by a life insurance organization such as a commercial company or non-profit organization.

Yet another aspect of the invention is that an organ insurance policy is offered to people as part of life insurance policy.

Yet another aspect of the invention is an organ insurance policy, which states that deceased donor beneficiaries receive money for the organ donation.

Yet another aspect of the invention is that an organization that manages the organ insurance has the control on the donated organs and allocate the organs to people in need, which belong to the group of committed donors.

Still another aspect of the invention is that people can acquire an organ insurance policy without commitment to donate own organs, however they will pay for this insurance.

Still another aspect of the invention is that, people who acquired an organ insurance policy without commitment to donate own organs get lower priority, compared to priority of the committed donors, in receiving an organ from the group of committed donors.

Yet another aspect of the invention is that an insured person can pay money to cover the organ transplantation operation expenses.

Yet another aspect of the invention is that an organ insurance person is provided with a special identification means such as printed matter, magnetic card, smart card or any electronic device that stores data describing the insured person and type of insurance.

### DETAILED DESCRIPTION OF THE INVENTION

Today, human organs for organ transplantation are in great shortage since many people need organs as kidneys, liver, hearths and lungs. However the number of donors is small, as people do not see any substantial reason to donate organs. Organs cannot be sell in civilized societies, so money cannot be earned by organ donation. Moreover, a person committed to donate an organ can reach a position in which he himself needs an organ donation, yet he might die without receiving the badly needed organ, due the existing shortage in donated organs. It is therefore the aim of this invention to increase the number of people committed to organ donation.

Obviously, if all the living people would be committed to donate own organs in case of own death, than the shortage would come to its minimum and maybe disappear. Unfortunately, this is not the case.

To encourage people to become organ donors they should get something in return. This could be a guarantee that if they would need an organ donation for themselves, they will have priority in getting such donation, over those people who didn't committed for such organ donations. To arrange a group of committed organ donors an organization should be formed. When this group will be large enough, their commitment to donate their own organs in the case of their own death would significantly increase the number of organs available for transplantation. These donated organs will be first allocated to people in need which belongs to the group of the committed people. Thus a person who committed to donate his organs knows that he significantly increases the chance to receive an organ in case he would need such organ donation. On the other hand, when this insurance plan will be publicized along with the insurance policy, many people will join the insured group to insure the availability of organs in case they would need such. Thus, the group of committed people will grow rapidly and this will reduce the shortage of human organs in the society.

To facilitate the activities of the organization that manage the list of committed donors by publication and advertisement, the insured people will pay some money. This sum could be changed according to the period of commitment or the age of the committed person.

Today, organ transplantation operation is very expensive. Most people cannot afford such high expense. To help people arrange the required capital for such an operation, the following insurance plan should be done, in which every organ insured person, will pay a small amount of money for such a future operation. This sum could vary according to the age and health of the insured person from about $10 per month to several hundreds dollars. Thus, a large group of insured people will generate a considerable capital, enough to cover many organ transplantations operations. Moreover, a sizeable capital could finance a life insurance policy for the person who dies and donates his organs to the insured community. Thus, the relatives of the deceased donor would get some capital and that would certainly increase the number of people committed to donate their organs, as they would get a complete life insurance plan which includes:
A. In case of illness where organ transplantation is needed, they will get the organ and the capital to finance the expensive transplantation operation.
B. In case of death, their beneficiaries will get small fortune to compensate the loss of their kin.

It is expected that as the group of organ insured people increases, there will be more than enough organs to satisfy the demand of the organ insured community. Thus the organization, which manages all the aspects of organ insured people, who could be an insurance company, could be in a position to offer the non-insured community, human organs coming from the insured community. In such a case, the insurance company could issue organ insurance policy to people who refrain to donate their own organs. These non donors insured people will pay for the insurance and the insurance company could give them lower priority in getting organs coming from the committed donors, compared to committed donors. Thus, the insurance company could create three classes of priority:
1. Top priority to people who are committed to donate their own organs.
2. Second priority to people who purchase organ insurance but refrain from commitment to donate own organs.
3. Third priority, to non-insured people.

Thus, when organ insured person becomes ill and required an organ transplantation, his/her details will be transferred to the organ insurance organization and when an organ becomes available, the organ will be given, according to those people in need according to their priority formed by their type of insurance. It should be emphasized, that within the group of same priority, medical doctors would decide the priority to receive the organs.

To implement the organ insurance plan, an organization such as insurance company offers the public to join the organ insurance plan A healthy person signs a commitment valid for a month or more in which he donates his own organs to be transplanted to any person in need. According to this commitment, the insurance company would decide if the insured person organs will be given to other insured people or, in case where there is no demand for organs within the insured community, the ownership of the organ will be given to the hospital where the organs where organs were separated from the deceased donor.

If a deceased person is identified as a donor, either by organ insured card or any other document or identification means such as magnetic card, smart card or other type of read only memory device, or by finding his name on the list committed donors, then the hospital would separate the needed organs. The list of committed donors could be a paper list printed paper list or a computer record stored on a memory media such as diskette, CD-ROM or stored on a memory device accessed by a computer such as Internet web site or a telephone/cellular network computer. The names and other details of the donors can be arranged in computer database and that database is kept protected from unauthorized access by firewalls and access code could be required to read and write into this database.

When the hospital identifies a committed organ donor, the hospital authorities will look into the waiting list issued by the organization/insurance company and either sends the organ to other hospital, or invites a patient from the waiting list, issued by organ insurance organization, which issued the organ insurance policy, to be hospitalized for organ transplantation. In case where the available organs are not fitted to any one on the insurance waiting list, the hospital will give the organ to the most needed person. In case where more than one patient is on the waiting list, the organ will be given to the person who has higher priority. Priority is calculated according to certain rules. Top priority is to those who are committed to donate own organs in case of death. In addition, the date of joining the insurance is also a factor and the person, who has longer insurance period, has extra points in calculating the priority within the same type of insurance.

The insurance company can provide the committed person a donor identification card, which could be a magnetic card, smart card or any other identification means, carried by the insured person. The functions of this card could be: to identify himself in case he needs an organ transplantation and to be identified in case of death so the hospital can check his identification and in case his commitment to donate organs his valid, the hospital will take the organs and notify the insurance company on the available organs so that the insurance company would determine who will get the available organs.

The insurance company has an option to create a computer database of organs insured people. i.e., those who committed to donate their organs and a second group of people who refrain to donate their own organs, but prefer to become insured by paying a premium set by the insurance plan. Such database could be kept on an Internet server so that doctors from hospitals could enter the insurance company website donors and insured people who are on the insurance company waiting list. Thus the hospital stuff can choose the recipients, from the waiting list and ask him/her to arrive to a hospital, to take the organ transplantation operation.

Along with the organ insurance policy may offer an insurance to cover the transplantation operation expenses. In case of death, this insurance will be given to the deceased beneficiaries relatives.

It is expected that the while the group of donors is too small there would be cases that insured people could not be provided with organs when they need such. To reduce the probability of this shortage, the committed donors should be young and healthy persons to postpone the case when they themselves would need organ donation. However, in case where an insured person needs an organ donation and such organ is not available, the insurance company would compensate the insured person by paying him or his beneficiaries certain agreed upon sum of money.

It is expected that different commercial organizations will cooperate in order to form a larger group of committed organ donors thus increasing the availability of organs to those on the waiting lists.

It will be appreciated that the invention is not limited to what has been described hereinabove merely by way of example. Rather, the invention is limited solely by the claims, which follow.

1-15. (canceled)

16. An insurance plan, comprising:
a list of people committed to donating their organs, upon death, to other people included in said list of people prior to death of said other people, each person listed in said list of people being an organ insured person.

17. The insurance plan according to claim 16, wherein each said organ insured person in said list of people has priority in receiving an organ transplant from a person on said list of people over a person not listed on said list of people.

18. The insurance plan according to claim 16, further comprising lower priority organ insurance, wherein organs donated by each said organ insured person, but not required by said other people on said list of people, would be given to people who purchased said lower priority organ insurance.

19. The insurance plan according to claim 16, further comprising means for insurance confirmation, wherein each said person in said list of people would have said means for insurance confirmation identifying each said person as one said organ insured person.

20. The insurance plan according to claim 19, wherein said means for insurance confirmation is an identification card.

21. The insurance plan according to claim 20, wherein said identification card includes a magnetic identifying strip readable by a computer.

22. The insurance plan according to claim 19, wherein said means for insurance confirmation is in a data transferable format capable of transfer via a communication network.

23. The insurance plan according claim 16, further comprising an option for each said organ insured person of paying an additional premium for covering organ transplantation operation expenses.

24. The insurance plan according to claim 16, wherein a priority of receiving an organ transplant for each said organ insured person within a given class of organ transplantation priority is a higher priority as a period of insurance is longer.

25. The insurance plan according to claim 16, wherein a person not on said list of people would pay a fee for receiving an organ transplant.

26. The insurance plan according to claim 25, wherein said fee would be age-dependent and health-dependent.

27. The insurance plan according to claim 16, wherein upon death of a person on said list of people, beneficiaries of said person would receive a death insurance benefit payment.

28. The insurance plan according to claim 16, further comprising a payment by each said person on said list of people for inclusion on said list.
